(19) United States
(12) Patent Application Publication
(10) Pub. No.: US 2010/0283258 A1
(43) Pub. Date: Nov. 11, 2010

(54) Uninterruptible solar power

(76) Inventor: William Sheridan Fielder, Ojai, CA (US)

Correspondence Address: WILLIAM S. FIELDER, P.O. BOX 1221, OJAI, CA, 93024-1221, US

(21) Appl. No.: 12/799,955

(22) Filed: May 4, 2010

Related U.S. Application Data
(60) Provisional application No. 61/215,558, filed on May 6, 2009.

(51) Int. Cl. F02B 63/04; F03G 6/06

(52) U.S. Cl. 290/1 E; 60/641.15

(57) ABSTRACT

Solar energy storage is achieved by capturing the rotational energy produced by a solar thermal energy system's turbines, and storing that energy in an energy storage spring, via a gear or a connected gear box/transmission, in a very efficient and scalable manner. Another gear box/transmission connected to the energy storage spring provides uninterrupted rotational energy, at a constant rate, to the system's electric generators, making it possible to provide base-load power. The stored rotational energy may also be released only during periods of peak demand, providing frequency regulation, in what is known as a peaker power plant. Previously, this instant on and off operation was only available in hydroelectric power plants. Stored rotational energy may also be utilized to provide a continuous pumping means, as well as to energize other machinery that relies on rotational energy, whereby performing work without generating electricity or burning fuel of any sort.

### CROSS-REFERENCE TO RELATED APPLICATIONS

This application claims the benefit of provisional patent application Ser. No. 61/215,558 filed May 6, 2009 by the present inventor, and is incorporated by reference.

This application is a new use application for the “Self-Winding Generator”, U.S. Pat. No. 7,127,886 B2, issued Oct. 31, 2006 by the present inventor, and is incorporated by reference.

### FEDERALLY SPONSORED RESEARCH

None.

### SEQUENCE LISTING

None.

### BACKGROUND

### Prior Art

Current means of storing solar energy include: heat storage methods, pumped water storage, flywheels, compressed air, batteries, and hydrogen. Heat storage methods include: steam accumulators, molten salt, graphite heat storage, and phase-change materials.

These methods don't provide for continuous, uninterrupted operation, are more expensive, require more risk, are not available everywhere, and are less efficient than the present disclosed embodiments.

For example, when the temperature of molten salt falls below its melting point, it freezes in the system's thermal energy circulation pipes. If the molten salt is pumped through the system by utilizing electricity, then the power consumed by this process makes the overall system less efficient. Pumped water storage isn't available everywhere, and it loses efficiency due to evaporation and heat loss from the pumps and generators involved in the process. Compressed air storage is also unavailable everywhere, and where it is, air leaks and heat, generated from motors during compression, add to inefficiency. Flywheels are less efficient because they require electricity to energize the magnetic bearings that levitate the flywheel. Batteries are costly; they degrade over time, and eventually require recycling. Hydrogen, as a means of storing energy, is expensive and not always practical.

### SUMMARY

A solar thermal collection means transfers thermal energy to a steam generator that produces the steam necessary to rotate at least one turbine. Turbines transform the kinetic energy in the steam into rotational energy that is transferred to an energy storage spring, or an array of springs. An energy storage spring is similar to that of the mainspring found in a self-winding watch. Rotational energy is transferred to the energy storage spring, usually via a gear or a gear box/transmission, at a rate significantly greater than the rate at which it is released from the energy storage spring, usually by another gear box/transmission, in order to provide continuous rotational energy, as is required for base-load power plants. Multiple transmissions/gear boxes may be required for additional springs.

The present embodiments will also allow concentrated solar thermal power plants to store rotational energy indefinitely, enabling them to provide electricity during periods of peak demand, thus providing frequency regulation, as is found in peaker power plants, and may connect to the national electric power grid. This ability to instantly switch the electric generators on and off was previously only available in hydroelectric power plants.

The rotational energy stored in energy storage springs may also be utilized to energize pumps and other machinery, for continuous operation.

The energy storage spring can be made of any material which is both flexible and strong enough to allow for the extreme pressures placed upon it. Additional energy storage springs may be necessary for uninterrupted operation or to allow a facility to expand its capacity as demand dictates.

This means of energy storage is very efficient, highly scalable, requires less maintenance, can be deployed anywhere, and presents fewer points of failure than do other methods.

### ADVANTAGES

This is a new use patent for the Self-Winding Generator (U.S. Pat. No. 7,127,886 B2) that featured uninterrupted rotational energy for ocean energy systems. In this new use of the Self-Winding Generator, the source of inconstant kinetic energy is the steam generated in solar thermal electric power plants, and in parabolic dish solar thermal collectors.

The energy storage spring(s) store(s) inconstant rotational energy, from a solar plant's turbine(s), or from a parabolic dish's connected turbine(s), and provide(s) constant rotational energy to the site's electric generator(s), without interruption. This technique effectively transforms kinetic energy into potential energy, and back again into kinetic energy, in a highly efficient manner. This enables the power plant to provide base-load power.

Besides providing constant rotational energy, this new use of the Self-Winding Generator may also include the release of rotational energy on demand, for the generation of electricity during periods of peak demand, thus providing frequency regulation. This enables power providers to instantly switch the power plant on and off, an advantage only available in hydroelectric power plants, up until now.

Pumps and other machinery that rely on rotational energy will also be able to operate continuously, eliminating the need for first transforming rotational energy into electricity, and then back again into rotational energy, and will function with enhanced efficiency.

Other benefits include highly efficient and scalable energy storage, as well as fewer points of failure, lower maintenance costs, and deployment anywhere a solar thermal power generation means is installed. Another benefit is the ability to perform work without the need to generate electricity or to burn fuel of any sort.

### DRAWINGS

### Figures

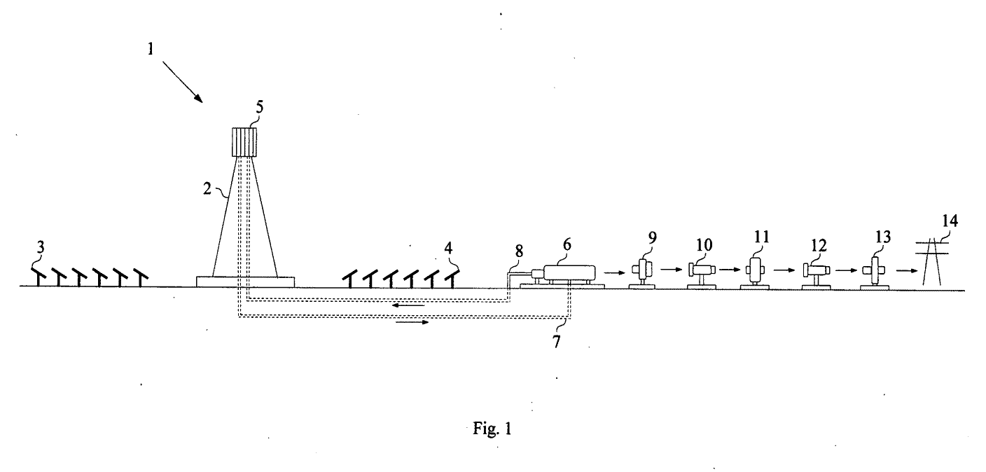

FIG. 1 is a power tower type concentrated solar thermal electric power plant that incorporates an energy storage spring between the system's turbine and its electric generator.

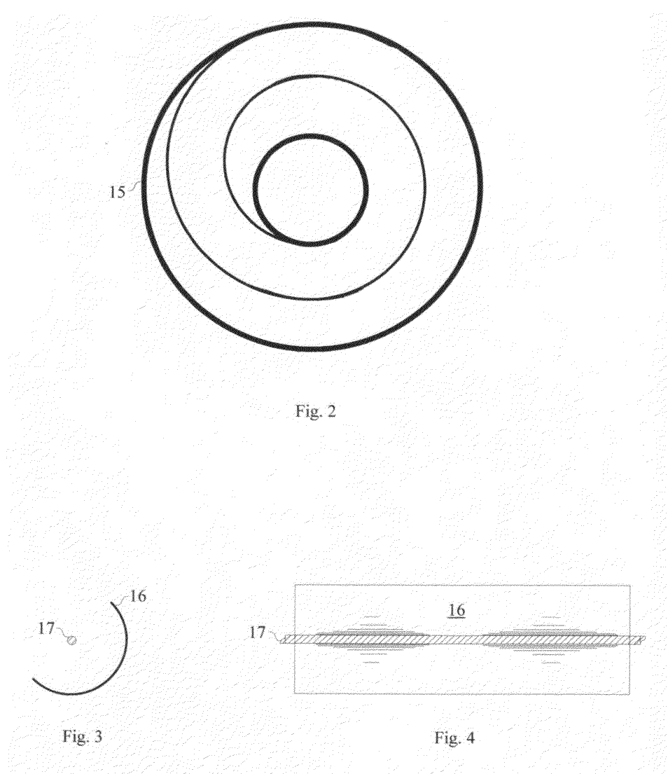

FIG. 2 is an example of an energy storage spring.

FIG. 3 is a side view of a parabolic trough type concentrated solar thermal reflector with an oil circulation pipe mounted at its focal point.

FIG. 4 is the front view of the previous parabolic trough reflector with the oil circulation pipe extending the length of the reflector.

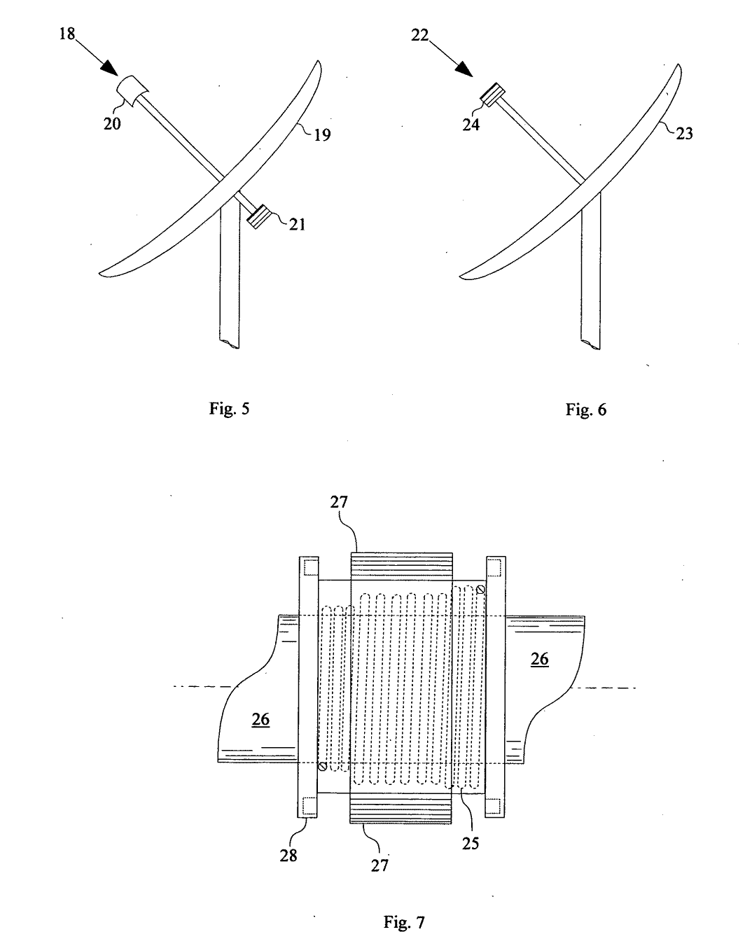

FIG. 5 depicts a parabolic dish type concentrated solar thermal collector that incorporates a sub-reflector to increase the solar thermal energy captured by the dish.

FIG. 6 depicts a parabolic dish type solar thermal collector that mounts the solar thermal collector at the focal point of the dish.

FIG. 7 is an alternative embodiment of an energy storage spring, where the spring is formed in an elongated spiral curve, such as that of an automobile's suspension spring.

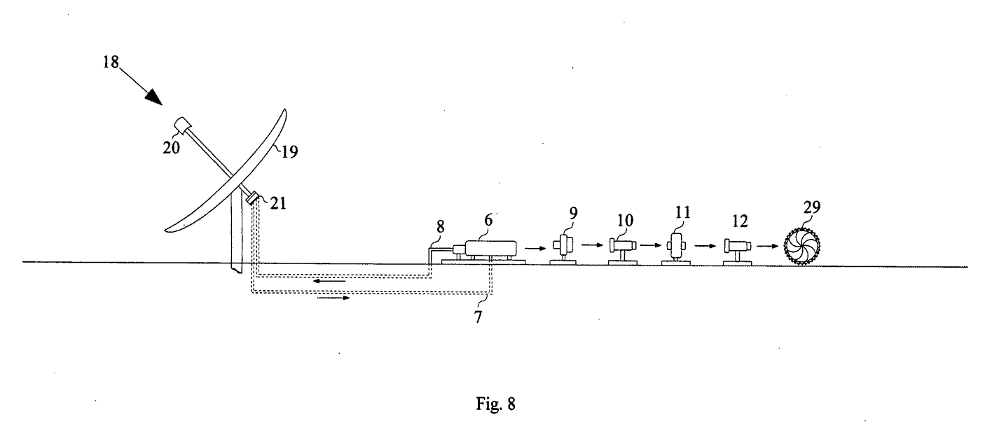

FIG. 8 is a parabolic dish type concentrated solar thermal power plant that incorporates an energy storage spring between the system's turbine and a pump.

### DRAWINGS

### Reference Numerals

1. Power tower type concentrated solar thermal electric power generation plant
2. Solar tower
3. Array of solar reflecting panels (mirrors)
4. Array of solar reflecting panels (mirrors)
5. Solar thermal collector, a.k.a. receiver
6. Steam generator
7. Hot oil circulation pipe, intake
8. Cooled oil circulation pipe, exhaust
9. Turbine
10. Gear box/transmission
11. Energy storage spring
12. Gear box/transmission
13. Electric generator
14. Electric power grid
15. Energy storage spring
16. Parabolic trough type concentrated solar thermal collector
17. Oil circulation pipe
18. Parabolic dish type concentrated solar thermal collector
19. Parabolic dish
20. Sub-reflector
21. Solar thermal collector, receiver
22. Parabolic dish type concentrated solar thermal collector
23. Parabolic dish
24. Solar thermal collector, receiver
25. Elongated energy storage spring
26. Axle
27. Rotational energy connecting element, a gear
28. Rotor
29. Pump

### Detailed Description

### FIG. 1

A solar thermal collector 5, a.k.a. receiver, is mounted on a tower 2 at the focal point of at least one array of solar reflecting mirrors 3, 4 optimally arranged around the tower 2. A hot oil circulation pipe 7 connects the solar thermal receiver 5 to the steam generator 6. The cooled oil circulation pipe 8 connects the steam generator 6 back to the solar thermal receiver 5. The steam generator 6 connects to a turbine 9 that connects ultimately to at least one energy storage spring 11. A transmission/gear box 10 attaches between the turbine 9 and the energy storage spring 11. Another gear box/transmission 12 connects the energy storage spring 11 to the electric generator 13 that connects to the electric power grid 14.

FIG. 2 illustrates an example of an energy storage spring 15.

### Operation

### FIG. 1

Sunlight is reflected off of the power plant's arrays of mirrors 3, 4, that are continuously tracking the sun, and onto the solar tower's thermal receiver 5. Oil circulated through the receiver 5 is super heated and transported via pipe 7 to the steam generator 6, where it boils water to create the steam that drives the power plant's turbine 9. The cooled oil is transferred back to the solar thermal receiver 5 via the cooled oil circulation pipe 8. The turbine 9 transfers rotational energy to the energy storage spring 11 via a gear box/transmission 10. Rotational energy is released and transferred from the energy storage spring 11 to the electric generator 13 by a gear box/transmission 12. The electricity produced by the electric generator 13 is used to energize the electric power grid 14.

### Alternative Embodiment

### FIGS. 3 and 4

In this embodiment the only change is in the type of solar power collection means incorporated. The parabolic trough 16 design suspends the oil circulation pipe 17 at the focal point of the trough and extends for the length of the reflector 16.

### Operation

### FIGS. 3 AND 4

Operation of the system is the same as depicted in FIG. 1, including steam generation 6, rotational energy capture 9, transference of rotational energy to the energy storage spring 11, and the release and transference of rotational energy to the electric generator 13.

### Alternative Embodiment

### FIG. 5

In this embodiment the solar power collection means is a parabolic dish type solar collector 18. An extended tube, or an array of tubes arranged in a tripod structure, not shown, is fastened to the dish 18 and is used to suspend a sub-reflector 20 at the focal point of the dish. Attached to back of the dish is the solar thermal collector 21. A hole in the dish 19, not shown, allows the reflected sun light to pass through the dish and on to the solar collector 21. The solar thermal circulation means, not shown, connects to the solar thermal collector, and then, as previously disclosed, to a steam generator 6, as shown in FIG. 1, that attaches to a turbine 9, that connects to a gearbox/transmission 10, that attaches to an energy storage spring 11, that attaches to another gearbox/transmission 12, and ultimately to an electric generator 13.

### Operation

### FIG. 5

Actuators or other means, not shown, are used to constantly position the dish 19 to the proper azimuth and elevation so as to maximize energy capture during sunlight hours. Sunlight is reflected from the dish 19 to the sub-reflector 20 and is then focused through a hole in the dish 19 on to the solar thermal collector 21. Operation of the remaining system, not shown, including steam generation 6, energy capture 9, connections to the energy storage spring 11, and the electric generator 13, remains the same as described in the first embodiment.

### Alternative Embodiment

### FIG. 6

This embodiment also incorporates a parabolic dish style solar thermal collector 22. An extended tube, or array of tubes in a tripod structure, not shown, suspends a solar thermal collector 24 at the dish's 23 focal point. The solar thermal circulation means, usually an insulated pipe, not shown, connects to the solar thermal collector 24, usually through, or attached to the tube, or one of the tubes used to suspend the solar collector 24. Then, as previously disclosed in FIG. 1, the thermal circulation means connects to a steam generator 6 that attaches to a turbine 9, that connects to a gearbox/transmission 10, that attaches to an energy storage spring 11, that attaches to another gearbox/transmission 12, and ultimately to an electric generator 13.

### Operation

### FIG. 6

Operation of the energy storage spring 11 remains the same. Actuators, or other means, not shown, constantly position the dish 23 to the proper azimuth and elevation, to maximize energy capture during sunlight hours. Sunlight is reflected by the dish 23 and focused on to the solar thermal collector 24. Operation of the remaining system, not shown, including steam generation 6, energy capture 9, rotational energy transfer to the energy storage spring 11, and the electric generator 13, remains the same.

### Alternative Embodiment

### FIG. 7

An elongated energy storage spring 25 is wrapped around and attaches to an axle 26 on one end, and to a rotor 28 on the other end that also supports the rotational energy connecting element 27. This structure may be included anywhere that the previously described energy storage spring 15 may be installed.

### Operation

### FIG. 7

The operation of this embodiment is identical to that of the first embodiment disclosed.

### Alternative Embodiment

### FIG. 8

A parabolic dish style solar thermal collector 18 suspends the solar thermal collector 21 that attaches to the hot oil circulation pipe 7 that connects to the steam generator 6. The cooled oil circulation pipe 8 connects the steam generator 6 back to the solar thermal receiver 21. The steam generator 6 connects to a turbine 9 that connects ultimately to at least one energy storage spring 11. A transmission/gear box 10 attaches between the turbine 9 and the energy storage spring 11. Another gear box/transmission 12 connects the energy storage spring 11 to the pump 29.

### Operation

### FIG. 8

The operation of this embodiment is identical to that of the first embodiment disclosed except that rotational energy is stored in the energy storage spring 11, and released by the gear box/transmission 12, which energizes a pump 29.

### Alternative Embodiment

### Not Shown

A solar power collection means transfers thermal energy in the form of steam, instead of superheated oil, from the receiver to the system's turbine directly, eliminating the need for a steam generator.

Operation of the energy storage spring and other apparatus remains the same.

### Alternative Embodiment

### Not Shown

A solar power collection means that transfers thermal energy in the form of molten salt to the system's steam generator may also be utilized. Energy storage springs may be the primary means, or secondary means of storing energy in this embodiment.

Operation of the energy storage spring and of the other components remains the same as previously disclosed.

### CONCLUSIONS, RAMIFICATIONS, and SCOPE

The reader will see that according to the embodiments disclosed, the means are provided to supply uninterrupted rotational energy, at a constant rate, in concentrated solar thermal power plants. When rotational energy is released only during periods of peak demand, then frequency regulation is provided.

While the above description contains many specificities, these should not be construed as limitations on the scope of the embodiments, but merely as providing illustration of some of the presently referenced embodiments.

A concentrated solar thermal power plant may contain electric generators of various sizes to most efficiently utilize the rotational energy available.

Other concentrated solar thermal collector systems that will benefit from the present embodiments include: solar pyramids, Fresnel reflectors, Linear Fresnel reflector (LFR) and compact-LFR technologies, Fresnel lenses, and MicroCSP.

The pumping embodiment, as described above, is applicable to the solar tower and parabolic dish embodiments, described above, as well. A solar powered pump, capable of continuous operation, is ideal for aqueducts and for other types of pipelines.

Rotational energy may also be provided by fuel fired sources such as internal combustible engines or fuel fired steam generators. Wind turbines may also be utilized.

Other machinery that will benefit from stored rotational energy include, lathes, drills, grinders, planers, saws, mills, cranes, elevators, and air compressors. An amusement park's rides, such as carousels and ferris wheels, will also benefit.

Multiple energy storage springs, per electric generator, or other apparatus, may be necessary for continuous operation. These springs may be connected in series, or in parallel by multiple gear boxes/transmissions.

Some possible enhancements include: magnetic bearings to increase efficiency, flywheels for frequency regulation, lightweight parts that are made from carbon fiber and other composites, and springs that are fabricated from memory metal.

Heat exchangers or other heat collecting elements, positioned at strategic locations in a mirror field, may also increase efficiency.

A braking system may also be added.

Rotational energy may be applied to and harvested from an energy storage spring by the same gear box/transmission.

Control systems orchestrate the entire process, from solar thermal capture, to interfacing with the electric power grid and/or other apparatus.

Non-concentrated solar thermal systems may also benefit by incorporating the technologies described here.

The energy storage spring may be fabricated from, but not limited to, stainless steel, a metal alloy, a memory metal, or from composites.

On an even smaller scale, the energy storage spring utilized may be of the carbon nanotube spring type.

Accordingly, the scope of the embodiments should be determined not by the embodiments illustrated, but by the appended claims and their legal equivalents.

I claim:

1. A method for providing a continuous supply of rotational energy derived from solar thermal energy comprising:
collecting solar thermal energy;
transforming said solar thermal energy into rotational energy;
transferring said rotational energy to at least one energy storage spring;
releasing the stored rotational energy from said energy storage spring;
whereby providing a means of supplying continuous rotational energy;
whereby providing a means of supplying rotational energy at a constant rate;
whereby performing work without generating electricity or burning fuel of any sort.

2. The method for providing a continuous supply of rotational energy derived from solar thermal energy, as claimed in claim 1, wherein said means of collecting solar thermal energy is a solar tower.

3. The method for providing a continuous supply of rotational energy derived from solar thermal energy, as claimed in claim 1, wherein said means of collecting solar thermal energy is a parabolic trough solar thermal collector.

4. The method for providing a continuous supply of rotational energy derived from solar thermal energy, as claimed in claim 1, wherein said means of collecting solar thermal energy is a parabolic dish solar thermal collector.

5. The method for providing a continuous supply of rotational energy derived from solar thermal energy, as claimed in claim 1, wherein said means of transforming said solar thermal energy into rotational energy is a steam generator.

6. The method for providing a continuous supply of rotational energy derived from solar thermal energy, as claimed in claim 1, wherein said means of transforming said solar thermal energy into rotational energy further includes a turbine.

7. The method for providing a continuous supply of rotational energy derived from solar thermal energy, as claimed in claim 1, wherein said means of transferring said rotational energy to said energy storage spring is a gear box/transmission between said turbine and said energy storage spring; whereby providing a control means for the operation of the energy storage spring.

8. The method for providing a continuous supply of rotational energy derived from solar thermal energy, as claimed in claim 1, wherein said means of releasing the stored rotational energy is a gear box/transmission means;
whereby providing a means of supplying uninterrupted rotational energy at a constant rate;
whereby performing work without generating electricity or burning fuel of any sort.

9. A method for providing a continuous supply of rotational energy derived from solar thermal energy comprising:
collecting solar thermal energy;
transforming said solar thermal energy into rotational energy;
transferring said rotational energy to at least one energy storage spring;
releasing the stored rotational energy from said energy storage spring;
whereby providing a means of supplying continuous rotational energy;
whereby providing a means of supplying rotational energy at a constant rate;
whereby performing work without generating electricity or burning fuel of any sort.

10. The method for providing a continuous supply of rotational energy derived from solar thermal energy, as claimed in claim 9, wherein said means of collecting solar thermal energy is a solar tower.

11. The method for providing a continuous supply of rotational energy derived from solar thermal energy, as claimed in claim 9, wherein said means of collecting solar thermal energy is a parabolic trough solar thermal collector.

12. The method for providing a continuous supply of rotational energy derived from solar thermal energy, as claimed in claim 9, wherein said means of collecting solar thermal energy is a parabolic dish solar thermal collector.

13. The method for providing a continuous supply of rotational energy derived from solar thermal energy, as claimed in claim 9, further including a steam generator.

14. The method for providing a continuous supply of rotational energy derived from solar thermal energy, as claimed in claim 9, further including a turbine.

15. The method for providing a continuous supply of rotational energy derived from solar thermal energy, as claimed in claim 9, wherein said means of transferring said rotational energy to said energy storage spring is a gear box/transmission between said turbine and said energy storage spring; whereby providing a control means for the operation of the energy storage spring.

16. The method for providing a continuous supply of rotational energy derived from solar thermal energy, as claimed in claim 9, wherein the means of releasing the stored rotational energy is a gear box/transmission means;
whereby providing a means of supplying uninterrupted rotational energy at a constant rate;
whereby performing work without generating electricity or burning fuel of any sort.

17. The method for providing a continuous supply of rotational energy derived from solar thermal energy, as claimed in claim 9, further including an electric generator; whereby providing electricity at a constant frequency.

18. The electric generator, as claimed in claim 17, further including at least one means of connecting to the national power grid, wherein said means are electric transmission lines; whereby enabling the plant to produce base-load power or to provide frequency regulation.

19. The method for providing a continuous supply of rotational energy derived from solar thermal energy, as claimed in claim 9, further including a pump;
whereby providing a continuous pumping means;
whereby eliminating the need for first transforming rotational energy into electricity and then transforming said electricity back again into rotational energy;
whereby eliminating the need for burning fuel of any sort;
whereby efficiency is maximized.

20. A method for providing frequency regulation for electric power comprising:
collecting solar thermal energy;
transforming said solar thermal energy into rotational energy;
transferring said rotational energy to an energy storage spring;
releasing said stored rotational energy from said energy storage spring;
whereby providing uninterrupted rotational energy at a constant rate on demand for an electric generator;
whereby providing a means frequency regulation.
